(19) United States
(12) Patent Application Publication
(10) Pub. No.: US 2007/0054175 A1
(43) Pub. Date: Mar. 8, 2007

(54) Electrode and composite structural unit for a fuel cell and fuel cell having the electrode or the structural unit

(75) Inventors: Michael Maendle, Thierhaupten (DE); Norbert Berg, Darmstadt (DE); Pertti Kauranen, Tampere (FI)

Correspondence Address: LERNER GREENBERG STEMER LLP, P O BOX 2480, HOLLYWOOD, FL, 33022-2480, US

(73) Assignee: SGL Carbon AG

(21) Appl. No.: 11/516,158

(22) Filed: Sep. 6, 2006

(30) Foreign Application Priority Data
Sep. 6, 2005 (EP) 05 019 291.3

(51) Int. Cl. H01M 4/86; H01M 4/96

(52) U.S. Cl. 429/40; 429/44

(57) ABSTRACT

An electrode for fuel cells includes several consecutive layers of electrically conductive porous material. The consecutive layers include recesses which form sections of flow channels. Within the individual layers, however, the channels are not continuous. When the consecutive layers are combined, the channel sections of the various layers, which are disposed in such a way that there are overlaps between them, complement one another to form a complete fluid-distributor structure. A distribution of fluid also takes place in the thickness direction of the electrode by virtue of the fact that the flow channels pass over repeatedly from one layer into the other, besides the distribution of fluid in a plane. A composite structural unit for fuel cells and a polymer-electrolyte-membrane fuel cell, are also provided.

### CROSS-REFERENCE TO RELATED APPLICATION

This application claims the priority, under 35 U.S.C. §119, of European application EP 05 019 291.3, filed Sep. 6, 2005; the prior application is herewith incorporated by reference in its entirety.

### BACKGROUND OF THE INVENTION

### FIELD OF THE INVENTION

The invention relates to electrodes for fuel cells with a multilayer flow field structure. The invention also relates to a composite structural unit for a fuel cell and a fuel cell having the electrode or the structural unit.

A concept for fuel cells, which is known from U.S. Pat. No. 5,252,410, is distinguished in that flow paths for a planar distribution of reactants are not, as conventionally, located in surfaces of a separator facing towards the electrodes, but rather in the electrodes themselves. That concept has several advantages in comparison with the prior art having structured separator surfaces.

For instance, separators that do not have to accommodate a flow field structure may be constructed to be thinner, so that the space requirement of the fuel-cell stack diminishes. Due to their function of separating the reactants, the separators are formed of dense and therefore heavy material. A reduction in their thickness would also significantly lessen the weight of the fuel-cell stack.

A further advantage resides in the fact that, as a result of relocation of the flow field structure into the electrodes, the reactants get closer to the catalyst-coated electrode/electrolyte-membrane interfaces where the electrochemical reactions take place.

In addition, shaping is generally less difficult with the lightweight, porous materials of the electrodes than with the dense and rigid materials of the separators.

A fuel cell according to U.S. Pat. No. 5,252,410 includes, in detail:
two electrically conducting separator layers that are impervious to fluids;
a membrane-electrode assembly embedded between the two separator layers, being formed of two porous electrodes layers, between which a proton-conducting membrane is located, with catalyst layers at the interfaces between the electrodes and the membrane;
the first electrode having an inlet and an outlet for a fuel as well as measures for transporting the fuel within the electrode from the inlet to the outlet; and
the second electrode having an inlet and an outlet for an oxidizing agent as well as measures for transporting the oxidizing agent within the electrode from the inlet to the outlet.

The measures for transporting the reactants from the inlet to the outlet over the electrode surface are provided, in the simplest case, by the pores of the electrode material itself. Alternatively, channels are sunk into the electrode surfaces facing towards the separators, similarly to the channel structures (flow fields) known from the state of the art in the separator surfaces facing towards the electrodes. According to U.S. Pat. No. 5,252,410, discontinuous channels may also be provided, i.e. a first group of channels extends from the inlet, and a second group of channels extends from the outlet, with the channels of the first group not being directly connected to those of the second group. At the ends of the channels of the first group, the fluid flowing through the channels from the inlet is forced to cross over into the pore structure of the electrode and in that way arrives in the vicinity of the catalyst layer. The channels of the second group serve for removal of the reaction products and unconverted substances. This configuration of the flow channels is constructed as being “interdigitated.”

In a preferred embodiment of U.S. Pat. No. 5,252,410, the separator is formed of graphite foil, and the electrodes accommodating the fluid-distributor structures are formed of carbon-fiber paper.

### SUMMARY OF THE INVENTION

It is accordingly an object of the invention to provide an electrode and a composite structural unit for a fuel cell and a fuel cell having the electrode or the structural unit, which overcome the hereinafore-mentioned disadvantages of the heretofore-known devices of this general type and in which the electrodes have channel structures for distribution of reactants which, unlike conventional channel structures, not only bring about a planar distribution of the reactant in the x-y plane but also route a reactant flow within the electrode simultaneously in the z-direction, i.e. towards a catalyst layer.

With the foregoing and other objects in view there is provided, in accordance with the invention, an electrode, comprising at least two porous conductive layers having recesses formed therein. The recesses are disposed in a pattern causing the recesses in consecutive layers to partially overlap and complement one another to form a channel structure for distribution of fluids. The channel structure has channels formed by the recesses interacting and having multiple transitions between the at least two layers. A further porous conductive layer does not have any recesses and is configured to be in contact with a catalyst layer.

Therefore, according to the invention, the electrode is constructed from several consecutive layers of electrically conductive porous material. The channel structure extends, as viewed from the separator, through at least two consecutive layers of the electrode and is terminated by an uninterrupted layer, i.e. not including any channels, which adjoins the catalyst layer.

The layers encompassing the channel structure each include several recesses which form sections of flow channels. Within the individual layers, these channels are not continuous. However, when the layers are combined to form the electrode according to the invention, the channel sections, which are disposed in such a way that there are overlaps between the channel sections of the consecutive layers, complement one another to form the desired channel structure. By virtue of the fact that the flow channels formed in this way have several transitions between the layers, a reactant flow in the thickness direction takes place besides the reactant flow in the plane.

The electrode according to the invention consequently includes, as viewed from the separator, at least two porous conductive layers provided with recesses, the recesses being disposed in a pattern such that they complement one another to form the desired channel structure, as well as a porous conductive layer that does not include any recesses. This final layer of the electrode according to the invention is in contact with the catalyst layer, i.e. it is itself coated with a catalyst and adjoins the electrolyte layer, or it is not catalyst-coated and adjoins the electrolyte layer which, for its part, is catalyst-coated.

With the objects of the invention in view, there is also provided a composite structural unit for fuel cells. The composite structural unit comprises an anode electrode according to the invention, a separator layer, and a cathode electrode according to the invention. The separator layer may include graphite foil.

With the objects of the invention in view, there is additionally provided a composite structural unit for fuel cells. The composite structural unit comprises an anode electrode according to the invention, an anode-side catalyst layer, an electrolyte layer, a cathode-side catalyst layer, and a cathode electrode according to the invention.

With the objects of the invention in view, there is furthermore provided a polymer-electrolyte-membrane fuel cell, comprising electrodes according to the invention, and separators made of graphite foil.

With the objects of the invention in view, there is concomitantly provided a polymer-electrolyte-membrane fuel cell, comprising composite structural units having an anode electrode formed of an electrode according to the invention, an anode-side catalyst layer, an electrolyte layer, a cathode-side catalyst layer, and a cathode electrode formed of an electrode according to the invention, and separators made of graphite foil.

Other features which are considered as characteristic for the invention are set forth in the appended claims.

Although the invention is illustrated and described herein as embodied in an electrode and a composite structural unit for a fuel cell and a fuel cell having the electrode or the structural unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view of a fuel cell with electrodes according to the invention;

FIGS. 2A, 2B and 2C are respective top-plan, top-plan and perspective views of a layer structure of an electrode according to the invention, with a first variant of a channel structure;

FIGS. 3A, 3B and 3C are respective top-plan, top-plan and perspective views of a layer structure of an electrode according to the invention, with a second variant of the channel structure; and

FIGS. 4A, 4B and 4C are respective top-plan, top-plan and perspective views of a layer structure of an electrode according to the invention, with a third variant of the channel structure.

### DESCRIPTION OF THE PREFERRED EMBODIMENTS

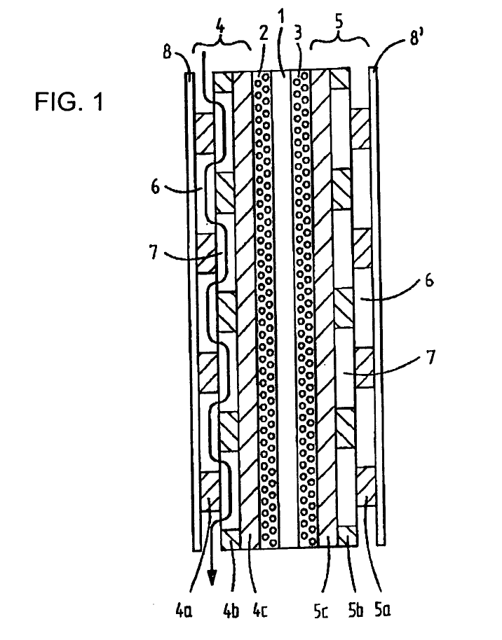

Referring now to the figures of the drawings in detail and first, particularly, to FIG. 1 thereof, there is seen a basic structure of a fuel cell with electrodes according to the invention. In this case, a polymer-electrolyte-membrane fuel cell (PEMFC) is represented in an exemplary manner. In principle, it is also possible for the structure of the electrodes, in accordance with the invention, to be applied to other types of fuel cells. The invention is also not tied to a particular fuel or to a particular oxidizing agent.

The core of the fuel cell is an electrolyte membrane 1 with an anode-side catalyst layer 2 and with a cathode-side catalyst layer 3. Alternatively, the catalyst layers may also be disposed on surfaces of anode and cathode electrodes 4, 5 facing towards the electrolyte membrane 1.

The anode-side catalyst layer 2 is adjoined by the anode electrode 4 which includes layers 4a, 4b, 4c, and the cathode-side catalyst layer 3 is adjoined by the cathode electrode 5 which includes layers 5a, 5b, 5c. The layers 4c and 5c of the respective anode and cathode electrodes 4 and 5, immediately adjoining the respective catalyst layers 2 and 3, have no recesses of any kind.

The following layers 4b, 4a and 5b, 5a, are provided with respective recesses 7, 6 which constitute individual sections of flow channels for the distribution of reactants within the electrodes 4, 5. The recesses in the consecutive layers are disposed in such a way that the recesses 6 in the layer 4a or 5a, interacting with the recesses 7 in the layer 4b or 5b, respectively provide a channel structure for the transport of respective reactants. By virtue of the fact that the recesses 6 in the layer 4a, Sa partially overlap with the recesses 7 in the layer 4b, 5b, the channel sections in the layer 4a, 5a are connected to those in the layer 4b, 5b. The course of the flow channels for the reactants formed in this way is illustrated in an exemplary manner by an arrow in FIG. 1 for the fuel in the anode electrode 4. When flowing through the channels, the reactant flow is repeatedly re-routed out of the respective outermost layer 4a and 5a, into the respective inner layer 4b and 5b, and thereby comes into closer proximity with the respective catalyst layer 2 and 3.

Accordingly, in contrast with the state of the art, the channels composed of the recesses 6 and 7 not only extend in the plane of the electrode but, at the transition between the layers, also change their direction perpendicular to this plane, i.e. in the thickness extension of the electrode. By virtue of this structure, the present invention opens up a further dimension for the optimization of the flow field structure, and a better distribution of the reactant within the electrode can be obtained.

Although FIG. 1 shows multilayer electrodes each of which includes two respective layers (4a, 4b and 5a, 5b) provided with recesses, and a respective uninterrupted layer (4c and 5c), the invention is not restricted thereto. The fluid-distributor structure may, as a matter of course, also include more than only two layers with mutually complementary recesses. The combination of more than two such layers allows more possibilities for variation in connection with the extension of the flow field structure in the thickness direction of the electrode, but it is associated with a greater expenditure of labor.

The fuel cell according to FIG. 1 is terminated by separator layers 8 and 8′ which, on one hand, establish an electrical connection to adjoining cells and, on the other hand, prevent mixing of the reactants between the adjacent cells. The separators in the fuel cell according to the invention do not have to accommodate any flow field structures and may therefore be relatively thin. The minimum thickness is determined by the requirement of imperviousness with respect to the reactants. In principle, all corrosion-resistant electrically conductive materials that, with a small thickness, are impervious to the reactants and mechanically stable, are suitable.

A suitable material for the separators is graphite foil, preferably with a thickness of from 0.3 mm to 1.5 mm and with a density of from 1.0 g/cm³ to 1.8 g/cm³. The greater the thickness and the density of the graphite foil, the lower the permeability with respect to the reactants. A large thickness of the separator, however, is undesirable for reasons of space and weight. If necessary, the permeability of the graphite foil can be lowered by impregnation with a suitable resin. Fuel-cell separators made of graphite foil, both without and with impregnation of the graphite foil, are known to persons skilled in the art. An alternative is represented by separators made of metal foil. In this case, however, corrosion problems are to be borne in mind.

The materials for the layers 4a, 4b, 4c and 5a, 5b, 5c constituting the electrodes 4 and 5 must be conductive and porous and should be capable of being easily provided with recesses. Suitable materials are papers (wet-laid non-wovens), non-wovens and felts made of carbon fibers or graphite fibers. These are optionally provided with an impregnation. It is possible for the porosity and the hydrophobicity/hydrophilicity of the electrode layers to be adjusted by the choice of the impregnating agents and by the degree of the impregnation.

It is also known to carbonize or to graphitize the impregnation. Examples of carbonizable impregnating agents are phenolic resins, epoxy resins and furan resins. Examples of non-carbonizable impregnating agents are fluorine-containing polymers such as PTFE. The impregnating agents may contain dispersed electrically conductive particles such as carbon black, graphite or the like, for the purpose of improving the electrical conductivity of the electrodes. After the carbonization of the impregnation, the electrodes are optionally also given a further impregnation for the purpose of adjusting the desired hydrophilicity/hydrophobicity, for example with a solution of Nafion® for the purpose of hydrophilizing, or with a suspension of PTFE for the purpose of hydrophobizing.

Suitable materials for electrodes are known from International Publication No. WO 01/04980, corresponding to U.S. Pat. No. 6,511,768 and European Patent Application EP 1 369 528, corresponding to U.S. Patent Application Publication No. US 2003/0194557 A1, for example. The individual electrode layers 4a, 4b, 4c and 5a, 5b 5c may be formed of different materials.

Within the electrodes, layers having varying porosity or/and having varying hydrophobicity/hydrophilicity, for example, may be combined, so that these parameters exhibit a gradient in the thickness direction of the electrode. The thickness of the layers 4a, 5a, 4b, 5b, 4c, 5c amounts to between 0.05 mm and 1 mm, with layer thicknesses of from 0.1 mm to 0.5 mm being preferred. It is possible for the individual layers within an electrode to have differing thicknesses. In particular, the layer 4c or 5c which is close to the catalyst, should be as thin as possible, in order to keep the diffusion path of the reactant from the flow channels to the catalyst layer as short as possible.

The anode electrode 4 and the cathode electrode 5 may, as a matter of course, differ from one another with regard to the configuration and the course of the flow channels, the porosity and hydrophobicity/hydrophilicity of the materials, the number and thickness of the individual layers, as well as the total thickness of the electrode. A person skilled in the art will select and optimize these parameters in a suitable manner in accordance with the fluid to be transported in the electrode (e.g. hydrogen, reformate, methanol or other alcohols, natural gas or other hydrocarbons as a fuel; oxygen or air as an oxidizing agent).

Production of the recesses is effected through the use of punching, water-jet cutting or similar techniques. The layers constituting the electrodes are either laid loosely on top of one another and given their cohesion when the fuel-cell stack is braced, or they are laminated together, so that prefabricated multilayer electrodes are obtained.

In a further development of the invention, the layers constituting the anode electrode 4, the separator layer 8, preferably made of graphite foil, and the layers constituting the cathode electrode 5 are laminated together or connected in some other way, so that a complete structural unit including anode electrode 4, separator 8 and cathode electrode 5 is obtained, with the anode surface and cathode surface being optionally provided with a respective catalyst layer 2 and 3.

Alternatively, an anode electrode 4 according to the invention and a cathode electrode 5 according to the invention can be combined with catalyst layers 2, 3 and with an electrolyte layer, for example an electrolyte membrane 1, to form a complete structural unit.

A particular advantage of the invention resides in the fact that the layers to be combined do not exhibit any elongated channels, as in conventional channel structures, but instead only the relatively short recesses 6, 7. By virtue of this, the handling of the electrode layers, e.g. in the course of assembly to form the electrodes according to the invention, is alleviated.

The porous electrodes are sealed at the edges through the use of an impregnation closing the pores, or by a plastic frame surrounding the electrode.

The respective supply of the electrodes with fuel and oxidizing agent, and the removal of the reaction products and unconverted substances, are effected in a known manner through the use of distributing and collecting lines (manifolds) traversing the fuel-cell stack. These manifolds are either constituted by aligned openings in the components of the fuel-cell stack (internal manifolding), or they are attached to the fuel-cell stack laterally (external manifolding). The channel structures of the anode electrodes are connected to the distributing line and to the collecting line for the fuel. The channel structures of the cathode electrodes are connected to the distributing line and to the collecting line for the oxidizing agent.

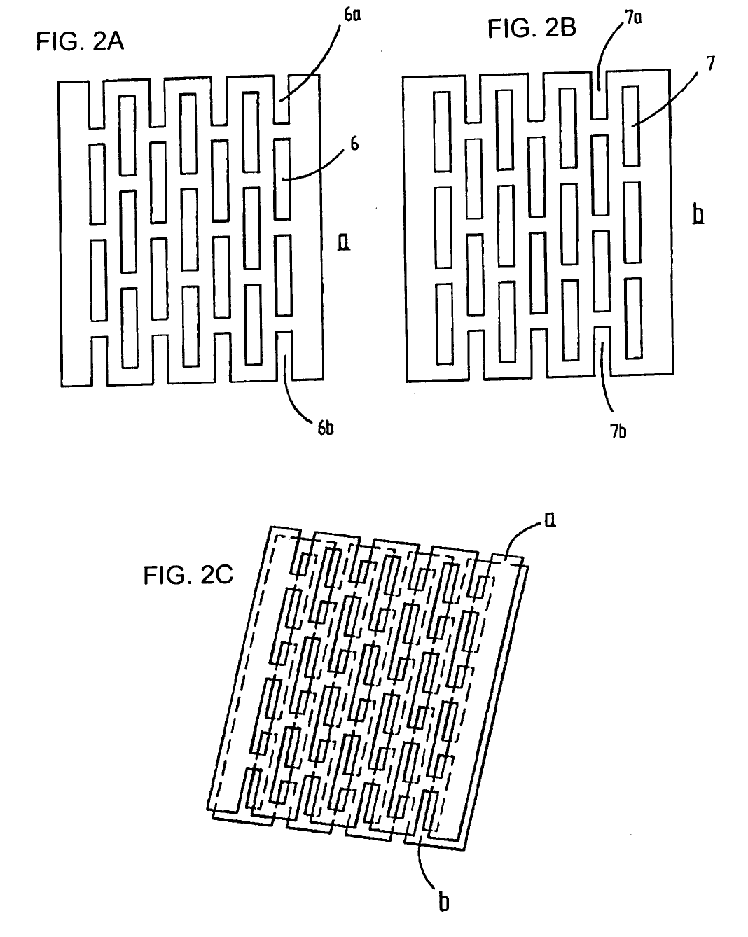

FIGS. 2A, 2B, 2C, 3A, 3B, 3C and 4A, 4B, 4C show various exemplary embodiments of the invention with different configurations of the recesses, each of which results in particular channel structures. These configurations may be used both for anode electrodes and for cathode electrodes. The layers of the electrode according to the invention that are provided with recesses will be designated generally below as layer a and layer b, with layer a being the layer in the fuel cell bearing against the separator (see also FIG. 1).

In order to provide a better overview, in FIGS. 2A, 2B, 2C, 3A, 3B, 3C and 4A, 4B, 4C only the layers a and b of the electrodes according to the invention have been represented, while the unstructured layers (4c and 5c in FIG. 1) which are close to the catalyst, have been omitted. The electrode layer a which adjoins the separator is shown individually in a top view in FIGS. 2A, 3A and 4A, and the following layer b is shown individually in a top view in FIGS. 2B, 3B and 4B. In addition, the configuration of the two layers a and b encompassing the flow field structure is represented in a perspective view in FIGS. 2C, 3C and 4C with the layer a being located at the top, so that the interaction of the recesses of the two layers can be discerned.

FIGS. 2A, 2B and 2C show a flow field structure which includes several parallel straight channels. The latter are constituted by several parallel rows of recesses 6, 7 in the layers a and b. Within these rows, the recesses 6 in the layer a are offset relative to the recesses 7 in the layer b in such a way that they partially overlap and in this manner complement one another to form continuous channels which repeatedly pass over from layer a into layer b and from layer b into layer a again in their course.

The supply of the reactant to the parallel channels is effected through a distributing channel which is not illustrated and which connects respective recesses 6a, 7a at the edge of the layers a and b, which act as entrances to the parallel channels, to the manifold (distributing line) for the supply of the corresponding reactant. The removal of the reactant is effected through a collecting channel which is not illustrated and which connects the recesses 6b, 7b at the opposite edge of the respective layers a and b, which act as exits of the parallel channels, to the manifold (collecting line) for the removal of the corresponding reactant. Each parallel channel has an entrance 6a or 7a, which opens into the distributing channel (not illustrated in FIG. 2), and an exit 6b or 7b, which opens into the collecting channel (not illustrated in FIG. 2), i.e. all of the parallel channels extend continuously from the distributing channel to the collecting channel.

In the variant represented in FIG. 2, channels having entrances 6a and exits 6b that are situated in the layer a alternate with those having entrances 7a and exits 7b that are situated in the layer b. Of course, other variants are also conceivable. For example, it is conceivable that the entrances and exits of all of the channels are located in one and the same layer, or the entrances of all of the channels are located in one layer and the exits in the other, or that channels with the entrance in the layer a and with the exit in the layer b alternate with those with the entrance in the layer b and with the exit in the layer a.

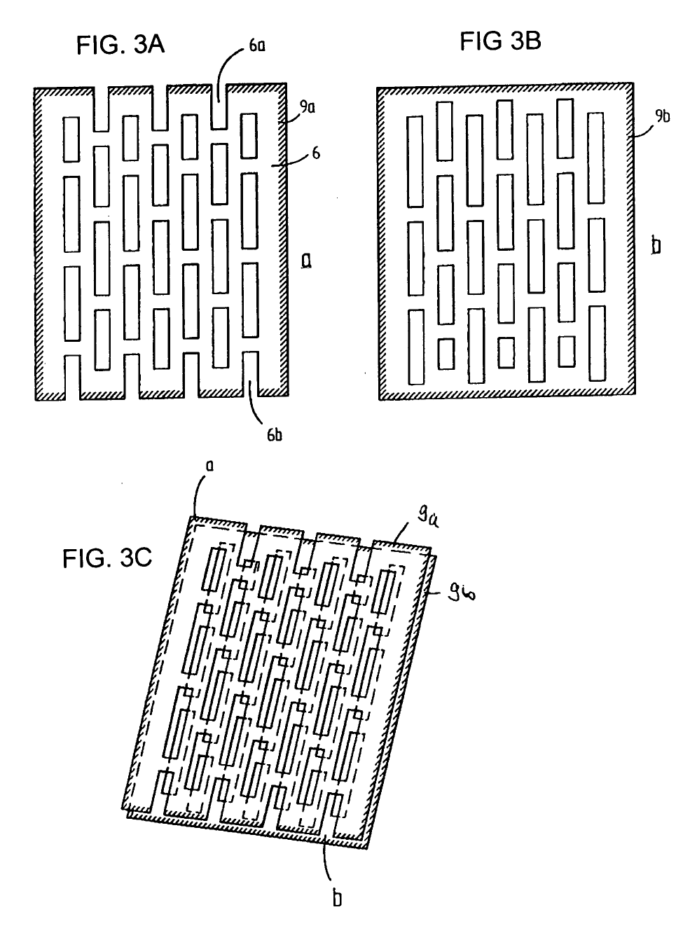

The channel structure in FIGS. 3A, 3B and 3C likewise includes several straight parallel channels which are constituted by several parallel rows of recesses 6, 7 partially overlapping one another in the consecutive layers a and b and passing over repeatedly from the layer a into the layer b and from the layer b into the layer a again in their course.

These channels of FIGS. 3A, 3B and 3C are discontinuous, as distinct from the channel structure evident from FIGS. 2A, 2B and 2C. A first group of channels has only one entrance 6a each, but no exit while a second group of channels has only one exit 6b each, but no entrance. The channels are preferably disposed alternately, so that in each instance a channel of the first group is followed by a channel of the second group, and conversely. This type of channel structure is known to persons skilled in the art by the designation “interdigitated”. Of course, other configurations of discontinuous channels are also possible.

The distribution of the reactant to the parallel channels of the first group is effected through a non-illustrated distributing channel which connects the entrances 6a thereof to the manifold (distributing line) for the supply of the corresponding reactant. The removal of the reactant or reaction products is effected through a non-illustrated collecting channel which connects the exits 6b of the channels of the second group to the manifold (collecting line) for the removal of the corresponding reactant.

The reactant flows from the entrances 6a through the channels of the first group. At the closed ends of these channels, which are preferentially located in the layer b, the crossing of the reactant into the porous electrode structure is forced, so that the reactant arrives in the vicinity of the catalyst-coated electrode/electrolyte interface. Unconverted portions of the reactant, and the reaction products, are removed through the channels of the second group through the exits 6b thereof. The porous conductive material is sealed at the edges of the electrode by an impregnation 9a, 9b closing the pores.

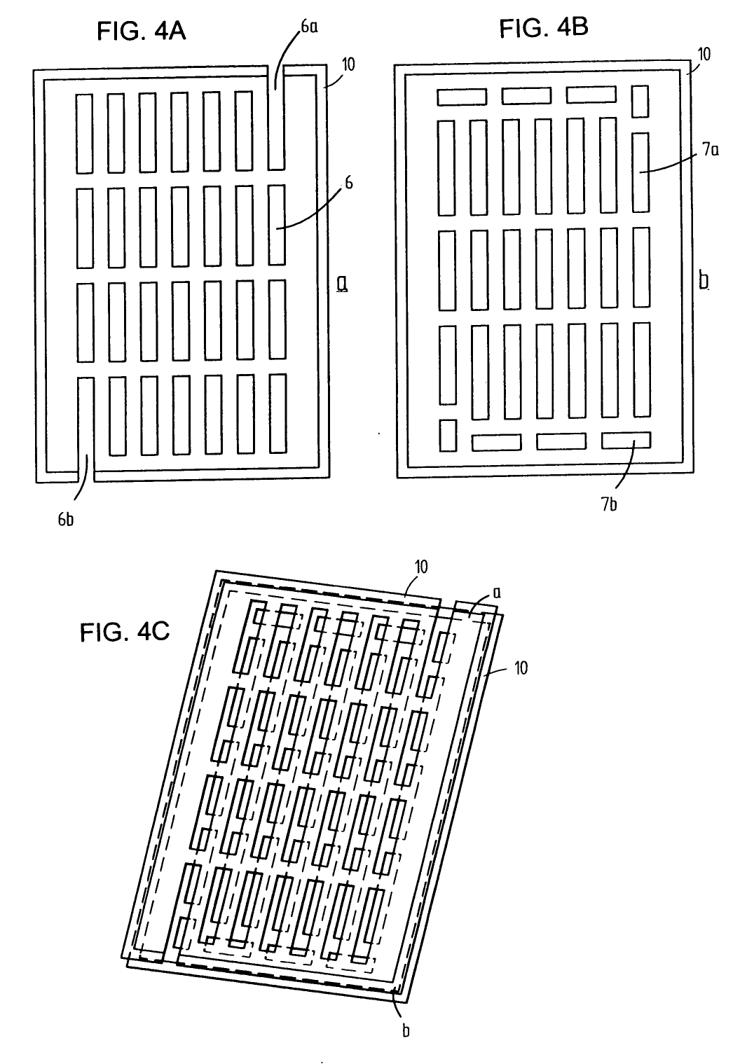

FIGS. 4A, 4B and 4C show a channel structure that includes only a single channel which extends in meandering or serpentine manner over the electrode surface and which alternates repeatedly from the layer a into the layer b and back in its course.

The layer a adjoining the separator has only recesses 6 disposed in longitudinal rows, which form sections of the longitudinal arms of the channel. The layer b has recesses 7a which are likewise disposed in longitudinal rows and which are complemented by the recesses 6 in the layer a, with which they partially overlap, to form the longitudinal arms of the serpentine channel. At each of the margins of the layer b there is located a row of recesses 7b, running transversely relative to the longitudinal rows of recesses 7a, which establish cross-connections between the longitudinal arms of the serpentine channel.

Modifications to this structure are possible as a matter of course, for example with the cross-connections in the layer a, or with some of the cross-connections in the layer a and with other cross-connections in the layer b, for example in such a way that the cross-connections of the longitudinal arms are situated alternately in layer a and in layer b.

The recess 6a, which acts as an entrance of the channel, is connected to the non-illustrated manifold (distributing line), for the supply of the corresponding reactant. The recess 6b, which acts as an exit of the channel, is connected to the non-illustrated manifold (collecting line), for the removal of the corresponding reactant. The porous conductive material is sealed at the edges of the electrode by a plastic frame 10.

The channel structures represented in FIGS. 2A, 2B, 2C, 3A, 3B, 3C and 4A, 4B, 4C are to be understood as being exemplary only. Above and beyond these, the present invention also encompasses all other possible structures that can be produced by the combination of appropriately disposed recesses in consecutive layers.

We claim:

1. An electrode, comprising:
at least two porous conductive layers having recesses formed therein;
said recesses being disposed in a pattern causing said recesses in consecutive layers to partially overlap and complement one another to form a channel structure for distribution of fluids;
said channel structure having channels formed by said recesses interacting and having multiple transitions between said at least two layers; and
a further porous conductive layer not having any recesses, said further porous conductive layer configured to be in contact with a catalyst layer.

2. The electrode according to claim 1, wherein said further porous conductive layer not having any recesses is configured to be coated with a catalyst.

3. The electrode according to claim 1, wherein said at least two porous conductive layers and said further porous conductive layer each have a thickness of between 0.05 mm and 1 mm.

4. The electrode according to claim 1, wherein said at least two porous conductive layers and said further porous conductive layer each have a thickness of between 0.1 mm and 0.5 mm.

5. The electrode according to claim 3, wherein said at least two porous conductive layers and said further porous conductive layer have different thicknesses.

6. The electrode according to claim 4, wherein said at least two porous conductive layers and said further porous conductive layer have different thicknesses.

7. The electrode according to claim 1, wherein said at least two porous conductive layers and said further porous conductive layer are formed of a porous conductive material selected from the group consisting of a paper, a non-woven and a felt made of carbon fibers or graphite fibers.

8. The electrode according to claim 7, wherein said paper is a wet-laid non-woven.

9. The electrode according to claim 7, wherein said at least two porous conductive layers and said further porous conductive layer are formed of different materials.

10. The electrode according to claim 7, wherein said porous conductive material has an impregnation.

11. The electrode according to claim 10, which further comprises electrically conductive particles dispersed in said impregnation.

12. The electrode according to claim 11, wherein said electrically conductive particles are selected from the group consisting of carbon black and graphite.

13. The electrode according to claim 10, wherein said impregnation is carbonized or graphitized.

14. The electrode according to claim 7, wherein said porous conductive material has an impregnation influencing hydrophilicity/hydrophobicity of said material.

15. The electrode according to claim 1, wherein said at least two porous conductive layers and said further porous conductive layer differ in at least one of porosity or hydrophilicity/hydrophobicity causing a porosity or hydrophilicity/hydrophilicity gradient in a thickness direction of the electrode.

16. The electrode according to claim 14, wherein said at least two porous conductive layers and said further porous conductive layer differ in at least one of porosity or hydrophilicity/hydrophobicity causing a porosity or hydrophilicity/hydrophilicity gradient in a thickness direction of the electrode.

17. The electrode according to claim 1, wherein said at least two porous conductive layers and said further porous conductive layer are formed of a porous conductive material, and said porous conductive material is sealed at edges of the electrode by an impregnation closing pores.

18. The electrode according to claim 1, wherein said at least two porous conductive layers and said further porous conductive layer are formed of a porous conductive material, and said porous conductive material is sealed at edges of the electrode by a plastic frame surrounding the electrode.

19. The electrode according to claim 1, wherein said channel structure formed by said interaction of said recesses in said consecutive layers includes continuous channels running parallel to one another.

20. The electrode according to claim 1, wherein said channel structure formed by said interaction of said recesses in said consecutive layers includes discontinuous channels.

21. The electrode according to claim 1, wherein said channel structure formed by said interaction of said recesses in said consecutive layers includes a channel running in serpentines.

22. The electrode according to claim 1, wherein said at least two porous conductive layers and said further porous conductive layer are laminated together.

23. A composite structural unit for fuel cells, the composite structural unit comprising:
an anode electrode formed of an electrode according to claim 1;
a separator layer; and
a cathode electrode formed of an electrode according to claim 1.

24. The composite structural unit for fuel cells according to claim 23, wherein said separator layer includes graphite foil.

25. A composite structural unit for fuel cells, the composite structural unit comprising:
an anode electrode formed of an electrode according to claim 1;
an anode-side catalyst layer;
an electrolyte layer;
a cathode-side catalyst layer; and
a cathode electrode formed of an electrode according to claim 1.

26. A polymer-electrolyte-membrane fuel cell, comprising:
electrodes according to claim 1; and
separators made of graphite foil.

27. A polymer-electrolyte-membrane fuel cell, comprising:
composite structural units having an anode electrode formed of an electrode according to claim 1, an anode-side catalyst layer, an electrolyte layer, a cathode-side catalyst layer, and a cathode electrode formed of an electrode according to claim 1; and
separators made of graphite foil.
